(19) United States
(12) Patent Application Publication
(10) Pub. No.: US 2004/0107579 A1
(43) Pub. Date: Jun. 10, 2004

(54) Two-handed cutting tool such as a pruner, hedge clippers, or the like

(76) Inventor: Antoine Deville, Vielil Bauge (FR)

Correspondence Address: BACHMAN & LAPOINTE, P.C., 900 CHAPEL STREET, SUITE 1201, NEW HAVEN, CT, 06510, US

(21) Appl. No.: 10/410,328

(22) Filed: Apr. 9, 2003

(30) Foreign Application Priority Data
Apr. 12, 2002 (FR) 0204624

(51) Int. Cl. B26D 3/16

(52) U.S. Cl. 30/100

(57) ABSTRACT

Each shank comprises at least a first segment which is close to the pivot axis and which extends substantially in the cutting plane in the same direction as the corresponding tang. Each of the two shanks further comprises at least a second segment extending beyond the first segment in a second direction which extends substantially in a respective shank plane containing said first direction and perpendicular to the cutting plane, the second direction forming a first angle with said first direction in said respective shank plane.

The present invention relates to a two-handed cutting tool, such as a pruner, hedge clippers or the like, comprising two active members, such as a cutting blade and an anvil blade, or two elongate cutting blades, mounted to pivot about a common transverse axis and adapted to pivot one against the other along a cutting plane perpendicular to the pivot axis, each active member having a corresponding rear end portion or “tang” beyond the pivot axis, which tang projects in a respective direction and is extended by a corresponding shank, each shank comprising at least a first segment which is close to said pivot axis and which extends in substantially the same direction as the corresponding tang.

### BACKGROUND OF THE INVENTION

The generally tubular shanks of known cutting tools are rectilinear, which makes the cutting tool compact when in the closed position, enabling the tool to be inserted easily among the branches of a tree, a copse, or a thicket.

The shanks, which act as lever arms, make it possible to apply a cutting force to the active members that is proportional to the length of the lever arm and to the force exerted on the end of said lever arm.

However, when the tool is a pruner, the muscular force that needs to be developed, e.g. the muscular force necessary to cut a branch having a diameter in the range 2 centimeters (cm) to 3 cm still remains large, and such a force can be required while the torso, the arms, the forearms and/or the wrists are in quite contorted positions. As a result, applying repeated cutting forces gives rise to tiredness, and sometimes also to pain.

### OBJECTS AND SUMMARY OF THE INVENTION

An object of the present invention is to remedy the above-mentioned drawbacks of known cutting tools of the above type, and to propose a cutting tool of this type that is of simple and reliable structure, making it possible to reduce the muscular forces required and to reduce the need for a user to be in a contorted position.

In the present invention, in the cutting tool of the above-mentioned type, each of the two shanks further comprises at least a second segment extending beyond the first segment in a second direction which extends substantially in a respective plane containing said first direction and perpendicular to the cutting plane, the second direction forming a first angle with said first direction in said respective plane.

The use of such a cutting tool requires the user to implement actions that are simpler and to take up upper-body, arm, forearm, and hand positions that are more comfortable, so that, surprisingly, the muscular force required is, in general, reduced.

The same applies for risks of muscle pain and/or of joint pain, such pain often being caused by prolonged use of a prior art cutting tool.

The person skilled in the art of cutting tools is reluctant to modify the conventional rectilinear shape of the shanks through fear of making the cutting tool more voluminous, and therefore more difficult to handle.

In fact, the cutting tool of the present invention is no more difficult to handle than a conventional cutting tool.

In an advantageous version of the present invention, with the cutting tool being a pruner comprising a cutting blade and an anvil blade, and the first direction extending substantially in the cutting plane, each shank further comprises a third segment beyond the second segment, which third segment, when projected on the respective corresponding plane in a third direction, forms a second angle with the corresponding second direction in said respective plane.

Such a structure makes a novel improvement to the operating positions and to the muscular forces to be developed while the cutting tool of the present invention is being used.

In an advantageous version of the invention, the third segment forms a third angle with the corresponding third direction, the two third segments extending, for example, between said respective planes.

In another version of the invention, with the tool being a pair of hedge clippers or the like comprising two substantially rectilinear elongate cutting blades, the tang of each active member extends in a respective first direction which extends in said respective plane containing said respective first direction and perpendicular to the cutting plane, said first direction forming an initial angle with the cutting plane, and the first angle is oriented preferably so as to bring the second segment towards the cutting plane.

### BRIEF DESCRIPTION OF THE DRAWINGS

Other features and advantages of the present invention appear from the following description.

In the accompanying drawings, which are given merely by way of non-limiting example:

FIGS. 1, 2, and 3 are respectively a perspective view, an elevation view, and plan view of a first embodiment of a cutting tool of the present invention;

FIGS. 4 and 5 are simplified diagrammatic views in perspective respectively on IV-IV and V-V in FIG. 3, showing only the axes of the various shank segments;

FIGS. 6, 7, and 8 are views similar respectively to FIGS. 1, 2, and 3 of a variant of the embodiment of a cutting tool of the present invention shown in FIGS. 1, 2, and 3;

FIGS. 9 and 10 are simplified diagrammatic views in perspective respectively on IX-IX and X-X in FIG. 8, showing only the axes of the various shank segments;

FIGS. 11 and 12 are respectively an elevation view and a plan view of a second embodiment of a cutting tool of the present invention; and

FIGS. 13 and 14 are simplified diagrammatic views in perspective respectively on XIII-XIII and XIV-XIV in FIG. 12, showing only the axes of the various shank segments.

### MORE DETAILED DESCRIPTION

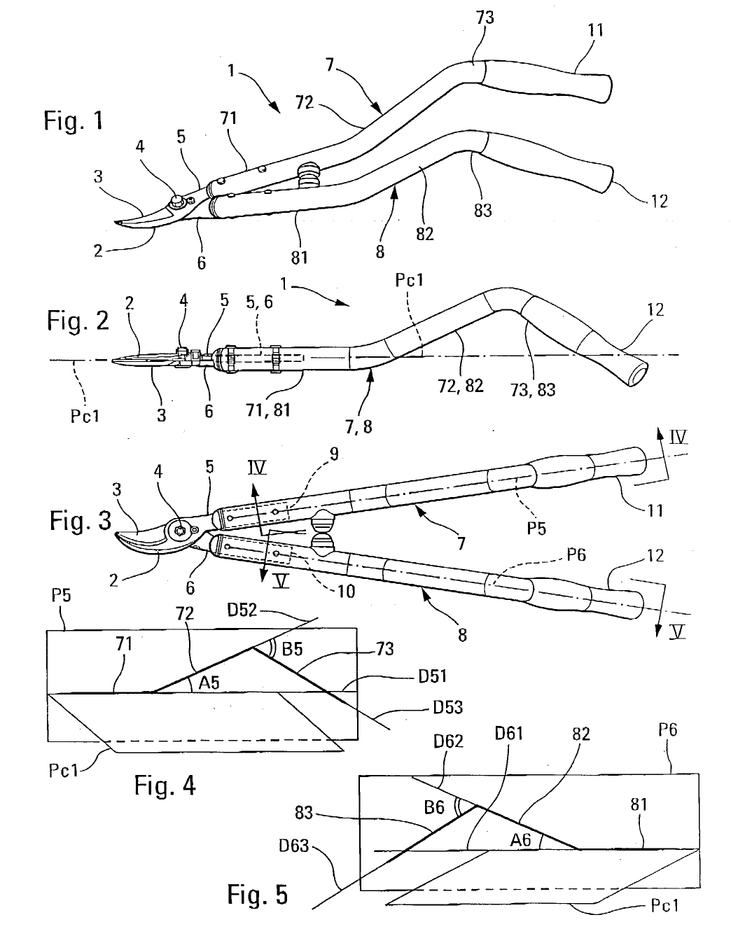

In the embodiment shown in FIGS. 1 to 5, the cutting tool 1 is a pruner comprising two active members 2, 3, namely a cutting blade 3 and an anvil blade 2, mounted to pivot about a common transverse axis 4.

The cutting blade 3 and the anvil blade 2 are adapted to pivot one against the other along a cutting plane Pc1 perpendicular to the axis 4 and shown diagrammatically in FIGS. 2 and 7.

Beyond the axis 4, the anvil blade 2 and the cutting blade 3 have corresponding rear end portions or “tangs” 5, 6 which extend in respective directions D5, D6, and which are extended by corresponding shanks 7, 8 which are in general tubular and which surround corresponding intermediate elements 9, 10 which are in general overmolded, and which are shown in dashed lines in FIGS. 3 and 8.

Each tubular shank 7, 8 can be mounted easily, in any known manner, around the corresponding tang 5, 6 and around the corresponding intermediate element 9, 10, and offers advantageous torsion strength for a determined weight. However, the following description also applies to non-tubular shanks mounted in any suitable known manner on the tangs 5, 6.

Each shank 7, 8 comprises at least a first segment 71, 81 which is close to the axis 4 and which extends substantially in the cutting plane Pc1 in the direction D51, D61 of the corresponding tang 5, 6.

To facilitate the description of the invention, and to simplify the figures, each shank segment is, by convention below, considered to be equivalent to its axis, it then being possible for each segment to be considered as lying substantially in the plane of its axis.

Each of the two shanks 7, 8 further comprises at least a second segment 72, 82. The second segment 72, 82 extends beyond the first segment 71, 81 in a second direction D52, D62 extending substantially in a respective shank plane P5, P6 which contains the first direction D51, D61 and which is perpendicular to the cutting plane Pc1 (see FIGS. 4 and 5).

In the respective shank plane P5, P6, the second direction D51, D62 forms a first angle A5, A6 with said first direction D51, D61 extended beyond the first segment 71, 81.

The first angle A5, A6 lies in the range 5° to 60°, advantageously in the range 15° to 40°, and preferably in the range 20° to 35°.

The angles A5 and A6 are preferably substantially equal.

As shown in FIGS. 1 to 5, each shank 7, 8 further comprises a third segment 73, 83 beyond the second segment 72, 82 going away from the axis 4, which third segment is projected on the respective corresponding plane P5, P6 in a third direction D53, D63 which, in said respective plane P5, P6, forms a second angle B5, B6 with the corresponding second direction D52, D62 extended beyond the second segment 72, 82 (see FIGS. 4 and 5).

The second angle B5, B6 lies in the range 20° to 120°, advantageously in the range 40° to 110°, and preferably in the range 50° to 100°.

The angles B5 and B6 are preferably substantially equal.

In the embodiment shown in FIGS. 1 to 5, the third segment 73, 83 lies within the corresponding plane P5, P6, and thus coincides with its projection in said plane.

FIGS. 4 and 5 thus diagrammatically represent the structure of the shank 7, 8 relative to the cutting plane PC and relative to the corresponding plane P5, P6.

More precisely, the axis, which is represented by the corresponding direction D51, D61, of the first segment 71, 81 of the shank 7, 8, lies both in the corresponding plane P5, P6 and substantially in the cutting plane Pc1 (or in a plane parallel to the plane Pc1 and very close thereto).

The axes, which are represented by the directions D52, D53, and D62, D63, of the second and third segments 72, 73, 82, 83 of the shank 7, 8, lie respectively within the corresponding plane P5, P6.

In the example shown in FIGS. 1 to 5, the second segments 72 and 82 are situated above the cutting plane Pc1, i.e. on the same side of said plane as the anvil blade 2.

It is also possible to provide second segments 72 and 82 extending on the other side of the cutting plane Pc1, i.e. on the same side of said plane as the cutting blade 3.

In the example shown, the angle B5, B6 is of the same sign as the angle A5, A6 relative to the direction D52, D62 extended beyond the second segment, so that the third segments 73, 83, or 74, 84 extend towards the cutting plane Pc1, the handles 11, 12 then extending towards said cutting plane Pc.

It is possible to imagine a cutting tool in which the angle B5, B6 is of the sign opposite to the sign of the corresponding angle A5, A6 relative to the direction D52, D62.

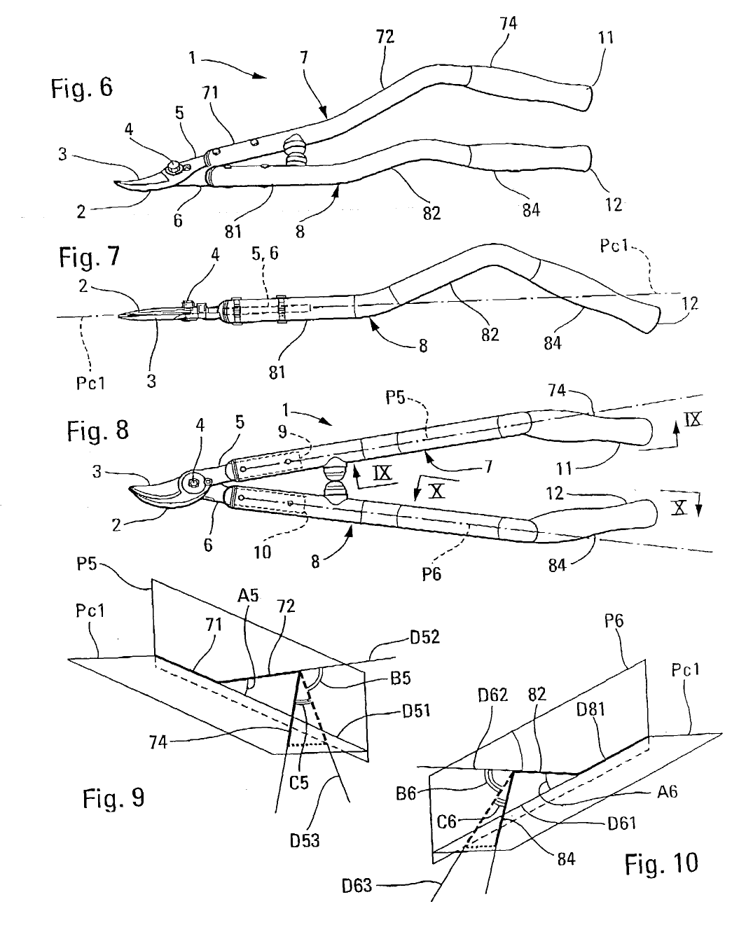

In the embodiment shown in FIGS. 6 to 10, the shank 7, 8 comprises first and second segments 71, 72, 81, 82 that are identical to those described above with reference to FIGS. 1 to 5, and that form an angle A5, A6 between them.

Beyond the second segment 72, 82, the shank 7, 8 further comprises a third segment 74, 84 which is projected on the respective corresponding plane P5, P6 in a third direction D53, D63 which, in the respective plane P5, P6, forms a second angle B5, B6 with the corresponding second direction D52, D62.

The third segment 74, 84 forms a third angle C5, C6 with the corresponding third direction D53, D63.

In this embodiment, the two third segments 74, 84 extend between the respective planes P5, P6, but they could also extend away from each other.

The third angle C5, C6 is in general less than 45°, advantageously less than 30°, and preferably less than 20°, this angle being measured on either side of the corresponding plane P5, P6.

The angles C5 and C6 are preferably substantially equal.

A cutting tool is thus described that, surprisingly, makes it possible to reduce the muscular forces required and to limit the extreme positions of the upper body, the arms, the forearms, and the wrists that are sometimes necessary when using a prior art cutting tool, and thus to limit the risks of muscle pain or joint pain caused by prolonged use of a cutting tool. Such a cutting tool is used for pruning trees, and in particular in fruit or other tree growing.

In a variant, it is possible to make provision for the second and third segments to extend relative to the preceding segments at angles of sign opposite to the sign of the angles described above.

It is also possible to make provision for the second segment 72, 82 of each shank 7, 8 to form an angle with the corresponding plane P5, P6 instead of lying within said plane. In which case, the angle A is the angle between the projection of the second segment 72, 82 on the plane P5, P6 and the corresponding first direction D51, D61.

It is also possible to make provision for the handles 11 and 12 to be fixed directly to the ends of the corresponding second segments.

Finally, it is also possible to associate the angled shanks described above, and including any of their variants, with a cutting blade 3 and an anvil blade 2 that are curved in the direction opposite to the direction shown in the figures, i.e. with the convex cutting edge of the cutting blade 3 being situated on the same side of the tool as the shank 7, i.e. facing towards the top of the sheet in each of FIGS. 1 and 3 and 6 and 8.

In any event, and in conventional manner, while such a cutting tool is being used, the cutting blade 3 is always situated closer to the trunk of the tree, i.e. closer to the upstream end of the branch to be cut, and is hidden from the user by the anvil blade 2 when the tool is in the closed position.

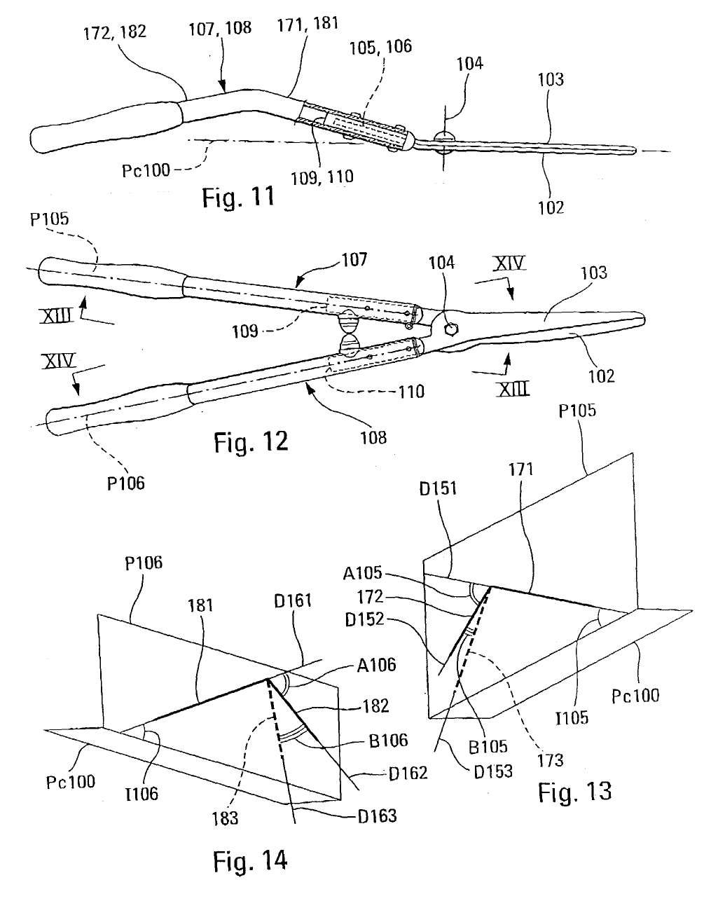

In the embodiment shown or represented in FIGS. 11 to 14, the two-handed cutting tool 101 is a pair of hedge clippers 101 comprising two active members 102, 103 constituted by substantially rectilinear elongate cutting blades that, in cross-section and in conventional manner, have substantially similar and symmetrical shapes.

The two cutting blades 102, 103 are mounted to pivot about a common transverse axis 104 and are adapted to pivot one against the other along a cutting plane Pc100 that is perpendicular to the pivot axis 104.

Beyond the pivot axis 104, each cutting blade 102, 103 has a corresponding tang 105, 106 which extends in a respective direction D151, D161 and which is extended by a corresponding shank 107, 108.

The tang 105, 106 of each cutting blade 102, 103 extends in a respective first direction D151, D161 which extends in a respective shank plane P105, P106 containing the respective first direction D151, D161 and perpendicular to the cutting plane Pc100.

The first direction D151, D161 forms an initial angle I105, I106 with the cutting plane Pc100. The purpose of the initial angle is to shift the hands of a user of the hedge clippers away from the cutting plane Pc100 and therefore from the portion of the hedge that is not trimmed and that remains after trimming.

Each shank 107, 108 comprises a first segment 171, 181 which is close to the axis 104 and which extends substantially in the direction D151, D161 of the corresponding tang 105, 106.

The tang 105, 106 is an integral part of the corresponding active member 102, 103 and is connected to said active member merely via a single bend or via any known more complex system of successive bends.

In the present invention, each of the shanks 107, 108 further comprises at least one second segment 172, 182 extending beyond the first segment 171, 181 in a second direction D152, D162 which extends substantially in said respective shank plane P105, P106 containing the first direction D151, D161, and which is perpendicular to the cutting plane Pc100.

In the respective plane P105, P106, the second direction D152, D162 forms a first angle A105, A106 with the corresponding first direction D151, D161 extended beyond the corresponding first segment 171, 181.

The first angle A105, A106 is preferably oriented so as to bring the second segment 172, 182 closer to the cutting plane Pc100.

The first angle A105, A106 lies in the range 20° to 120°, advantageously in the range 40° to 110°, and preferably in the range 50° and 100°.

The angles A105 and A106 are preferably equal.

In a variant represented diagrammatically in FIGS. 13 and 14, the second segment 173, 183 is projected on the respective plane P105, P106 in the corresponding second direction D152, D162, and forms a second angle B105, B106 with said second direction D152, D162, the second segments 173, 183 extending, for example, between the respective planes P105, P106.

The second angles B105 and B106 are in general substantially equal and they are in general less than 45°, advantageously less than 30°, and preferably less than 20°.

In the embodiment shown in FIGS. 11 to 14 and described above, the shanks 107, 108 are preferably tubular shanks surrounding corresponding intermediate elements 109, 110 in general overmolded onto the corresponding tangs 105, 106. However, the present invention is also applicable to non-tubular shanks connected in any known manner to the corresponding tangs 105, 106.

Naturally, the present invention is not limited to the above-described embodiments, and numerous changes and modifications may be made to them without going beyond the scope of the invention.

The present invention is applicable, in particular, to pruners and hedge clippers (or garden shears) of any type different from the type described above, e.g. to cutting tools having short blades comprising a rectilinear cutting blade and an anvil blade.

What is claimed is:

1/ A two-handed cutting tool comprising two active members mounted to pivot about a common transverse axis and adapted to pivot one against the other along a cutting plane perpendicular to the pivot axis, each active member having a corresponding rear end portion or “tang” beyond the pivot axis, which tang projects in a respective direction and is extended by a corresponding shank, each shank comprising at least a first segment which is close to said pivot axis and which extends in substantially the same direction as the corresponding tang, wherein each of the two shanks further comprises at least a second segment extending beyond the first segment in a second direction which extends substantially in a respective plane containing said first direction and perpendicular to the cutting plane, the second direction forming a first angle with said first direction in said respective plane.

2/ A cutting tool according to claim 1, with said cutting tool being a pruner comprising a cutting blade and an anvil blade, and the first direction extending substantially in the cutting plane, wherein the first angle lies in the range 5° to 60°, advantageously in the range 15° to 40°, and preferably in the range 20° to 35°.

3/ A cutting tool according to claim 1, wherein the angles and are substantially equal.

4/ A cutting tool according to claim 2, wherein each shank further comprises a third segment beyond the second segment, which third segment, when projected on the respective corresponding plane in a third direction, forms a second angle with the corresponding second direction in said respective plane.

5/ A cutting tool according to claim 4, wherein the second angle lies in at least one of the following ranges: broadly 20° to 120°, advantageously 40° to 110°, and preferably 50° to 100°.

6/ A cutting tool according to claim 4, wherein the angles are substantially equal.

7/ A cutting tool according to claim 4, wherein the third segment lies within the corresponding plane.

8/ A cutting tool according to claim 4, wherein the third segment forms a third angle with the corresponding third direction, the two third segments extending, for example, between the respective planes.

9/ A cutting tool according to claim 8, wherein the third angle lies in at least one of the following ranges: broadly less than 45°, advantageously less than 30°, and preferably less than 20°.

10/ A cutting tool according to claim 8, wherein the third angles are substantially equal.

11/ A cutting tool according to claim 1, with said tool being a pair of hedge clippers comprising two substantially rectilinear elongate cutting blades, wherein the tang of each active member extends in a respective first direction which extends in said respective plane containing said respective first direction and perpendicular to the cutting plane, said first direction forming an initial angle with the cutting plane, and wherein the first angle is oriented preferably so as to bring the second segment towards the cutting plane.

12/ A cutting tool according to claim 11, wherein the first angle lies in at least one of the following ranges: broadly 20° to 120°, advantageously 40° to 110°, and preferably 50° to 100°.

13/ A cutting tool according to claim 11, further comprising a second segment which is projected on the respective plane in the corresponding second direction and which forms a second angle with said second direction.
